(19) United States
(12) Patent Application Publication
(10) Pub. No.: US 2012/0162897 A1
(43) Pub. Date: Jun. 28, 2012

(54) MOUNTING APPARATUS FOR HARD DISK DRIVE

(75) Inventor: ZHEN-XING YE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/044,558

(22) Filed: Mar. 10, 2011

(30) Foreign Application Priority Data
Dec. 22, 2010 (CN) 201010600687.4

(51) Int. Cl. G06F 1/16

(52) U.S. Cl. 361/679.33

(57) ABSTRACT

A mounting apparatus includes a frame, a fixing box for receiving a hard disk drive, and two poles. A front end and a rear end of the frame each define two rows of positioning holes adjacent to opposite sides of the frame, respectively. The fixing box is received in the frame. The fixing box includes two opposite sidewalls each defining a through hole through a front end and a rear end of a corresponding one of the two sidewalls. The poles are respectively extended through two positioning holes respectively in the two rows of positioning holes of the front end of the frame at a same height, the through holes of the fixing box, and two corresponding positioning holes of the two rows of positioning holes of the rear end of the frame at the same height, and then engaging in two fasteners, to fix the fixing box to the frame.

### BACKGROUND

1. Technical Field

The present disclosure relates to a mounting apparatus for a hard disk drive.

2. Description of Related Art

Typically, a number of hard disk drives are mounted in a bracket of a server. However, the distance between every two adjacent hard disk drives is fixed. When the distance between two adjacent hard disk drives needs to be adjusted to better dissipate heat in different environments, the bracket has to be replaced, which is wasteful and troublesome.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an embodiment of a mounting apparatus together with a hard disk drive.

FIG. 2 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

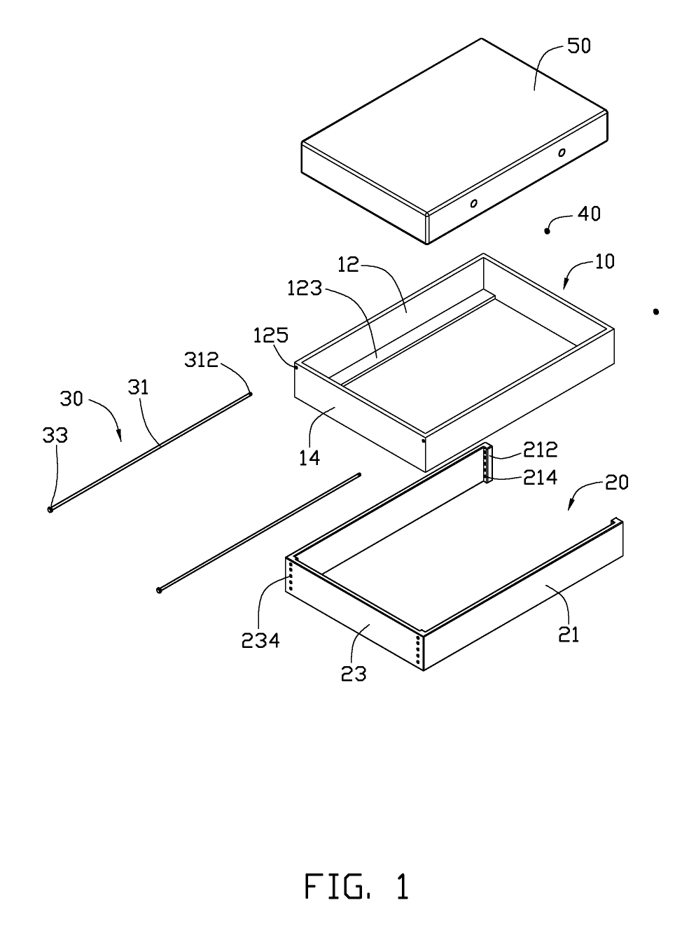

Referring to FIG. 1, an embodiment of a mounting apparatus includes a fixing box 10, a frame 20, and two poles 30.

The fixing box 10 includes two opposite sidewalls 12, and two end walls 14 respectively connected between front ends and rear ends of the sidewalls 12. A bottom wall 123 extends from each sidewall 12 towards the other sidewall 12. A through hole 125 is defined in an upper portion of each of the sidewalls 12 through the front end and the rear end of the sidewall 12.

The frame 20 includes two opposite side plates 21, and an end plate 23 perpendicularly connected between front ends of the side plates 21. Two stop plates 212 extend toward each other from rear ends of the side plates 21. Each of the stop plates 212 defines longitudinally a plurality of positioning holes 214. A plurality of positioning holes 234 is defined in the end plate 23 adjacent to each of the side plates 21. The positioning holes 234 of the end plate 23 align with the positioning holes 214 of the stop plates 212, respectively. In this embodiment, the distance between every two adjacent positioning holes 214, and the distance between every two adjacent positioning holes 234 are about 2.5 millimeters.

Each pole 30 includes an elongated main body 31. A flange 33 is formed on a front end of the main body 31. A threaded portion 312 is formed on a rear end of the main body 31.

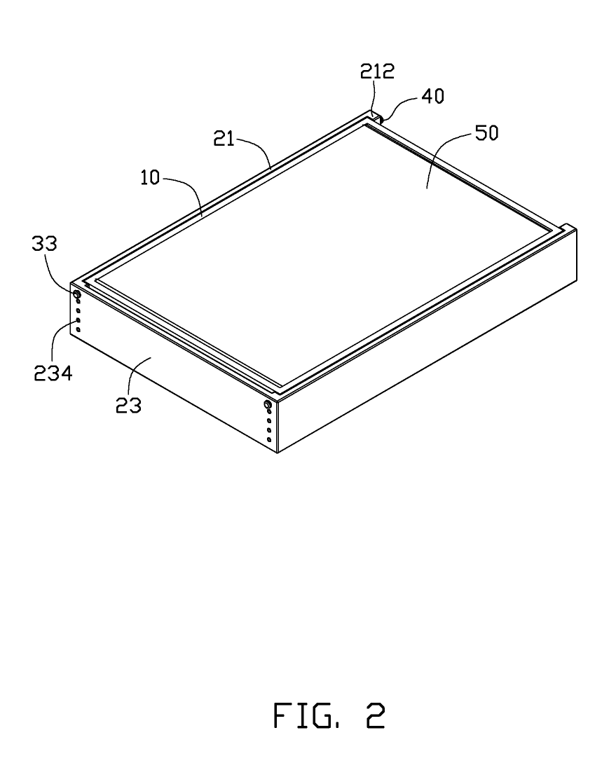

Referring to FIG. 2, to assemble a hard disk drive 50 to the mounting apparatus, the hard disk drive 50 is placed in the fixing box 10, and supported on the bottom walls 123. A plurality of fasteners, such as screws, is provided to fix the hard disk drive 50 to the fixing box 10. The fixing box 10 is arranged between the side plates 21 of the frame 20, to allow the through holes 125 of the fixing box 10 to align with the corresponding positioning holes 234 and 214 of the frame 20 at a same height. The poles 30 are extended through the corresponding positioning holes 234 of the end plate 23, the through holes 125 of the fixing box 10, and the corresponding positioning holes 214 of the stop plates 212, to allow the threaded portions 312 to engage in two corresponding nuts 40. Thereby, the fixing box 10 is fixed to the frame 20. The flanges 33 of the poles 30 abut a front side of the end plate 23 of the frame 20, and the nuts 40 abut the rear sides of the stop plates 212 respectively.

In use, the mounting apparatus together with the hard disk drive 50 is installed in a bracket of an electronic device (not shown). The hard disk drive 50 and other hard disk drives are vertically spaced. When there is a need to adjust the distance between the hard disk drive 50 and an adjacent hard disk drive, the nuts 40 are disengaged from the poles 30, to allow the poles 30 to be detached from the frame 20. The fixing box 10 is moved up or down, to allow the through holes 125 of the fixing box 10 to align with the corresponding positioning holes 234 and 214 of the frame 20 at a desired height, and with a desired distance defined between the hard disk drive 50 and the adjacent hard disk drive. The poles 30 are extended through the frame 20 and the fixing box 10, and then engaged in the corresponding nuts 40. Thereby, the fixing box 10 is fixed to the frame 20, and the distance between the hard disk drive 50 and the adjacent hard disk drive is adjusted.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mounting apparatus for a hard disk drive, the mounting apparatus comprising:
a frame, a front end and a rear end of the frame each defining two rows of positioning holes adjacent to opposite sides of the frame, respectively;
a fixing box for receiving the hard disk drive, the fixing box received in the frame, the fixing box comprising two opposite sidewalls each defining a through hole through a front end and a rear end of a corresponding one of the two sidewalls; and
two poles respectively extended through two positioning holes respectively in the two rows of positioning holes of the front end of the frame at a same height, the through holes of the fixing box, and two corresponding positioning holes of the two rows of positioning holes of the rear end of the frame at the same height, and then engaging in two fasteners, to fix the fixing box to the frame.

2. The mounting apparatus of claim 1, wherein the frame comprises two opposite side plates and an end plate connected between front ends of the side plates, two stop plates extend toward each other from rear ends of the side plates, the rows of positioning holes of the front end of the frame are defined in the end plate and respectively adjacent to the side plates, the rows of positioning holes of the rear end of the frame are respectively defined in the stop plates.

3. The mounting apparatus of claim 1, wherein the distance between every two adjacent positioning holes in each row are about 2.5 millimeters.

4. The mounting apparatus of claim 1, wherein each of the poles comprises an elongated main body, a flange is formed on a front end of the pole to abut the front end of the frame, the fasteners engage with rear ends of the poles and abut the rear end of the frame.

5. The mounting apparatus of claim 1, wherein the through holes are respectively defined in upper portions of the sidewalls.
